(19) United States
(12) Patent Application Publication
(10) Pub. No.: US 2006/0190188 A1
(43) Pub. Date: Aug. 24, 2006

(54) Methods and systems for determining lot consistency

(76) Inventor: Jozef J.P. Nauta, Weesp (NL)

Correspondence Address: FINNEGAN, HENDERSON, FARABOW, GARRETT & DUNNER;LLP, 901 NEW YORK AVENUE, NW, WASHINGTON, DC, 20001-4413, US

(21) Appl. No.: 11/337,502

(22) Filed: Jan. 24, 2006

Related U.S. Application Data
(60) Provisional application No. 60/646,869, filed on Jan. 25, 2005.
(60) Provisional application No. 60/706,449, filed on Aug. 9, 2005.

(51) Int. Cl. G06F 19/00

(52) U.S. Cl. 702/19

(57) ABSTRACT

This invention provides methods for determining lot consistency between a plurality of lots, systems for determining lot consistency between a plurality of lots, and computer-readable media which store a set of instructions which when executed performs a method for determining lot consistency between a plurality of lots.

### CROSS REFERENCE TO RELATED APPLICATIONS

This application claims priority under 35 U.S.C. § 119(e) to Provisional Application No. 60/646,869, filed Jan. 25, 2005, and Provisional Application No. 60/706,449, filed Aug. 9, 2005, the entire contents of which are hereby incorporated herein by reference.

### BACKGROUND OF THE INVENTION

I. Field of the Invention

The present invention generally relates to methods and systems for determining lot consistency. More particularly, the present invention relates to systems for determining lot consistency, for example, between three or more vaccine lots, in particular between three lots.

II. Background Information

Lot consistency testing is a process for determining the similarity between lots. When the lots comprise influenza vaccine, for example, lot consistency testing may show that lots are similar with respect to the immunogenicity of hemagglutinin (HA) of three viral strains contained in the vaccine. In other words, lot consistency testing may comprise equivalence testing. For testing with two lots (i.e. two treatments) and a single outcome, the statistical theory of equivalence testing is well established. Briefly, let Δ be the true treatment difference and δ the equivalence margin. The two treatments are considered equivalent if |Δ|<δ. To demonstrate equivalence, the null hypothesis H₀: |Δ|≧δ may be tested against the alternative hypothesis H₁: |Δ|<δ. If the null hypothesis is tested by the two one-sided tests procedure, this approach may comprise checking a two-sided 100(1-2α)% confidence interval for Δ that lies within the equivalence range −δ to δ.

A difficult aspect of equivalence testing may be the choice of the margin δ. However, in the case of influenza vaccine lot consistency testing, there may be two more challenges, both related to multiplicity in statistical testing. First, for licensure in the United States of America, for example, not two, but three lots need to be compared. Second, there may be three outcomes instead of one, one for each of three strains in the vaccine. Ignoring these multiplicities may increase the overall type I error rate (i.e. the probability of wrongly concluding that the lots are equivalent.)

In view of the foregoing, there is a need for methods and systems for determining lot consistency more optimally. Furthermore, there is a need for determining lot consistency between more than two vaccine lots where each lot contains multiple strains, for example.

### SUMMARY OF THE INVENTION

Consistent with embodiments of the present invention, systems and methods are disclosed for determining lot consistency.

In a first aspect, the invention provides a method for determining lot consistency between a plurality of lots, each of the plurality of lots being associated with each of a plurality of analytes. In an embodiment, the method comprises receiving level data elements, each one of the level data elements corresponding to one of the plurality of lots and one of the plurality of analytes; calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},

where Dij comprises a difference between two of the level data elements for an i^{th} lot and a j^{th} lot for a given one of the plurality of analytes, seᵢⱼ comprises a standard error of the difference, and δ comprises an equivalence margin; and determining that the plurality of lots are consistent when each of the plurality of test statistics exceeds a predetermined value.

In an embodiment of the method the lots are vaccine lots. In another embodiment of the method the level data elements are a measure of the immunogenicity of the vaccine lots. In another embodiment of the method the vaccine is influenza vaccine and the level data elements correspond to the immunogenicity of the influenza vaccine. In another embodiment of the method the immunogenicity of the influenza vaccine is determined by the hemagglutination inhibition test for anti-HA antibody titration. In another embodiment the method further comprises transforming non-normally distributed level data elements to obtain normally distributed level data elements. In further embodiments of the method δ is from 1.3 to 1.7 or from 1.4 to 1.6. In another embodiment of the method δ/seᵢⱼ is 5.0 or less. In another embodiment of the method each one of the plurality of lots is associated with more than one analyte, and a level data element corresponding to each of the more than one analytes associated with each of the plurality of lots is determined.

In another embodiment, the method comprises receiving level data elements, each one of the level data elements corresponding to one of the plurality of lots and one of the plurality of analytes; calculating, using the following equation, a plurality of test statistics, each one of the plurality of test statistics respectively corresponding to each one of the plurality of analytes,
Zmin=min{(δ−|Dᵢⱼ|)/seᵢⱼ},

where Dᵢⱼ comprises a difference between two of the level data elements for an i^{th} lot and a j^{th} lot for a given one of the plurality of analytes, seᵢⱼ comprises a standard error of the difference, and δ comprises an equivalence margin; and determining that the plurality of lots are consistent when each of the plurality of test statistics exceeds a predetermined value.

In another aspect, the invention provides a system for determining lot consistency between a plurality of lots, each of the plurality of lots being associated with each of a plurality of analytes. In an embodiment, the system comprises a memory storage for maintaining a database and a processing unit coupled to the memory storage, wherein the processing unit is operative to receive level data elements, each one of the level data elements corresponding to one of the plurality of lots and one of the plurality of analytes; and calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},

where Dij comprises a difference between two of the level data elements for an i^{th} lot and a j^{th} lot for a given one of the plurality of analytes, seᵢⱼ comprises a standard error of the difference, and δ comprises an equivalence margin, and determining that the plurality of lots are consistent when each of the plurality of test statistics exceeds a predetermined value.

In an embodiment of the system the lots are vaccine lots. In another embodiment of the system the level data elements are a measure of the immunogenicity of the vaccine lots. In another embodiment of the system the vaccine is influenza vaccine and the level data elements correspond to the immunogenicity of the influenza vaccine. In another embodiment of the system, the immunogenicity of the influenza vaccine is determined by the hemagglutination inhibition (HI) test for anti-HA antibody titration. In another embodiment of the system the processing unit is operative to transform non-normally distributed level data elements to obtain normally distributed level data elements. In further embodiments of the system δ is from 1.3 to 1.7 or from 1.4 to 1.6. In another embodiment of the system δ/seᵢⱼ is 5.0 or less. In another embodiment of the system each one of the plurality of lots is associated with more than one analyte, and a level data element corresponding to each of the more than one analytes associated with each of the plurality of lots is determined.

In another aspect, the invention provides a computer-readable medium which stores a set of instructions which when executed performs a method for determining lot consistency between a plurality of lots, each of the plurality of lots being associated with each of a plurality of analytes. In an embodiment, the method is executed by the set of instructions comprising receiving level data elements, each one of the level data elements corresponding to one of the plurality of lots and one of the plurality of analytes; and calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},

where Dij comprises a difference between two of the level data elements for an i^{th} lot and a j^{th} lot for a given one of the plurality of analytes, seᵢⱼ comprises a standard error of the difference, and δ comprises an equivalence margin, and determining that the plurality of lots are consistent when each of the plurality of test statistics exceeds a predetermined value.

In an embodiment of the computer-readable medium the lots are vaccine lots. In another embodiment of the computer-readable medium the level data elements are a measure of the immunogenicity of the vaccine lots. In another embodiment of the computer-readable medium the vaccine is influenza vaccine and the level data elements correspond to the immunogenicity of the influenza vaccine. In another embodiment of the computer-readable medium the immunogenicity of the influenza vaccine is determined by the hemagglutination inhibition (HI) test for anti-HA antibody titration. In another embodiment of the computer-readable medium the instructions further comprise transforming non-normally distributed level data elements to obtain normally distributed level data elements. In a further embodiment of the computer-readable medium δ is from 1.3 to 1.7 or from 1.4 to 1.6. In another embodiment of the computer-readable medium δ/seᵢⱼ is 5.0 or less. In another embodiment of the computer-readable medium each one of the plurality of lots is associated with more than one analyte, and a level data element corresponding to each of the more than one analytes associated with each of the plurality of lots is determined.

In a further aspect, the invention provides a method for determining lot consistency between a plurality of lots, each of the plurality of lots being associated with each of a plurality of analytes. An embodiment of the method comprises manufacturing the lots and taking samples from them, analyzing the analytes in the samples, and generating level data elements from the analyses, wherein each one of the level data elements corresponds to one of the plurality of lots and one of the plurality of analytes; calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},

where Dᵢⱼ comprises a difference between two of the level data elements for an i^{th} lot and a j^{th} lot for a given one of the plurality of analytes, seᵢⱼ comprises a standard error of the difference, and δ comprises an equivalence margin;

determining whether each of the plurality of test statistics exceeds a predetermined value and thus the plurality of lots are consistent; and, based on said consistency determination, taking a decision to use the lots, and/or to discard them, and/or to adjust the manufacturing process.

It is to be understood that both the foregoing general description and the following detailed description are exemplary and explanatory only, and should not be considered restrictive of the scope of the invention, as described and claimed. Further, features and/or variations may be provided in addition to those set forth herein. For example, embodiments of the invention may be directed to various combinations and sub-combinations of the features described in the detailed description.

### BRIEF DESCRIPTION OF THE DRAWINGS

The accompanying drawings, which are incorporated in and constitute a part of this disclosure, illustrate various embodiments and aspects of the present invention. In the drawings:

FIG. 1 is a block diagram of an exemplary lot consistency system, consistent with an embodiment of the present invention; and

FIG. 2 is a flow chart of an exemplary method for determining lot consistency consistent with an embodiment of the present invention.

### DETAILED DESCRIPTION

The following detailed description refers to the accompanying drawings. Wherever possible, the same reference numbers are used in the drawings and the following description to refer to the same or similar parts. While several exemplary embodiments and features of the invention are described herein, modifications, adaptations and other implementations are possible, without departing from the spirit and scope of the invention. For example, substitutions, additions or modifications may be made to the components illustrated in the drawings, and the exemplary methods described herein may be modified by substituting, reordering or adding steps to the disclosed methods. Accordingly, the following detailed description does not limit the invention. Instead, the proper scope of the invention is defined by the appended claims.

In the present disclosure, an “analyte” is a substance in a composition. In the context of a vaccine composition, an analyte may be, for example, an immunogenic component of the vaccine. Thus, in the context of an influenza vaccine an analyte may be a component of an influenza virus, such as hemagglutinin (HA) or neuraminidase (NA). A vaccine composition may contain one or more than one analyte.

In the present disclosure a “lot” is a unit of manufacture. Thus, a composition “lot” is a batch of the composition that has been manufactured. For example, a vaccine lot is a manufactured batch of vaccine.

A “level data element” is a measure of a characteristic of an analyte in a lot. Suitable characteristics include, for example, analyte concentration, total amount of analyte present in the lot, antigenicity, immunogenicity, or biological activity. In case of a biologically active analyte, a level data element may be a measure of the response induced by the analyte. A level data element may be created by combining measurements of various samples of a given lot. For example, a level data element can be created by calculating the arithmetic or geometric mean of the concentration of an analyte in a lot.

Systems and methods consistent with embodiments of the present invention may determine lot consistency. “Lot consistency” refers to variation of level data elements between lots that is within a predetermined range. For example, “consistency” may be determined with respect to the amount, concentration, or biological activity of an analyte in a lot. For example, the immunogenicity of influenza vaccines may be determined by the hemagglutination inhibition (HI) test for anti-HA antibody titration. The HI titer may be defined as a dilution factor of the highest dilution that still completely inhibits hemagglutination. For example, the starting dilution may be 1:10. From this dilution, further twofold dilutions may be prepared, for example: 1:20, 1:40, . . . , 1:2560. Thus, HI titers for example, can take the values 10, 20, 40, 80, . . . , 2560. If the starting dilution does not inhibit hemagglutination, a titer value of 5 may be assigned. Furthermore, every blood sample may be titrated twice and the HI titer assigned to the blood sample may the geometric mean of the two titrations. Accordingly, the geometric mean titer (GMT) may be used to summarize HI titers.

One possible approach to testing the similarity of lots is to compare the GMTs between lots for each strain. Techniques for establishing equivalence may be enhanced if the data are normally distributed. HI titers, however, tend to be skewed to the right. A log transformation may make the observations approximately normal. Consequently, a log transformation for HI titers may comprise:
log HI titer=log₂(HI titer/5).

The log HI titers may be identical to the aforementioned dilution steps, for example: 0 (HI titer 5), 1 (HI titer=10), 2 (HI titer=20), . . . , 9 (HI titer=2560). Furthermore, there is a one-to-one relationship between the arithmetic mean of the log-transformed HI titers (AMLT) and the GMT of the untransformed titers, for example:
GMT=2^{AMLT}×5.

Furthermore, let GMTᵢ and GMTⱼ denote the geometric mean titer of an i^{th} and an j^{th} lot, respectively, and let AMLTᵢ and AMLTⱼ denote the arithmetic means of the log-transformed HI titers. Then
2^{AMLTi-AMLTj}=GMTᵢ/GMTⱼ.

Thus, if the equivalence of the log-transformed HI titers is demonstrated by showing that AMLTᵢ−AMLTⱼ=0, then the equivalence of the HI titers may be demonstrated at the same time by showing that the geometric mean ratio (GMR) is close to one (i.e. GMTᵢ/GMTⱼ=1.)

Instead of using HI titers to demonstrate lot consistency, a baseline-corrected fold increases may be used. For example,

Fold Increase=HIT_{P}/HIT_{B}
with HIT_{B} and HIT_{P} being the baseline and the post-vaccination HI titer respectively.
Note that:
log Fold Increase=log HIT_{P}−log HIT_{B}.

Let MFIᵢ denote the geometric mean of the fold increases (i.e. mean fold increase) and GMT_{Bi} and GMT_{Pi} the geometric mean of the baseline and the post-vaccination HI titers of the i^{th} lot respectively. Then:
MFIᵢ/MFIⱼ=[GMT_{Pi}/GMT_{Pj}]/[GMT_{Bi}/GMT_{Bj}].

If there is no baseline imbalance in HI titers between the i^{th} and the j^{th} lot (i.e. GMT_{Bi}/GMT_{Bj}≈1), then the MFI ratio may be approximately equal to the GMR. For example:
MFIᵢ/MFIⱼ≈GMT_{Pi}/GMT_{Pj}

In the case of baseline imbalance, however, there may be a difference between the analysis of the fold increases and that of the post-vaccination HI titers. Accordingly, the use of the fold increases may not eliminate bias in the GMT due to baseline imbalance, it may actually introduce bias. Moreover, fold increases may be negatively correlated with baseline HI titers, for example, the higher the baseline HI titer, the smaller the fold increase. This means that if the baseline HI titers are imbalanced, the MFI will be highest for the lot with the lowest baseline values. One way to correct for baseline imbalance may be to use Analysis of Covariance. Nevertheless, there are challenges associated with this approach as well (e.g. heterogeneity of variance.) Thus, if there is no baseline imbalance between the lots, the analysis of the fold increases may yield the same results as the analysis of the post-vaccination HI titers. The analysis of the HI titers, however, may be more powerful because of the lower variability between the observations. It is a statistical rule that unless the correlation between the post-vaccination and the baseline HI titers is high, these differences will show greater variability than the post-vaccination HI titers themselves.

To demonstrate the equivalence of three influenza vaccine lots, for example, the differences between the lot means (of the log-transformed HI titers or the log-transformed fold increases) may be small. For a single strain, this may be done by testing the null hypothesis H₀: max|Δᵢⱼ|≧δ against the alterative hypothesis H₁: max|Δᵢⱼ<δ, where Δᵢⱼ is the true but unknown difference between the i^{th} and the j^{th} lot. The null hypothesis may be tested using the test statistic:
Zmin=min{(δ−|Dᵢⱼ|)/seᵢⱼ}

where Dᵢⱼ is the observed difference between the i^{th} and the j^{th} lot and seᵢⱼ the standard error of this difference. Let sd₁, sd₂ and sd₃ be the standard deviations of the lot means. Then
seᵢⱼ=√[sdᵢ²/nᵢ+sdⱼ²/nⱼ]

with nᵢ and nⱼ being the sample size of the i^{th} and the j^{th} lot respectively.

If the three differences D₁₂, D₁₃, and D₂₃ are consistent with H₀ (i.e. at least one |Dᵢⱼ|≧δ), then Zₘᵢₙ will be negative. If the differences are consistent with H₁ (i.e. all |Dᵢⱼ|<δ), then Zₘᵢₙ will be positive. The smaller the observed differences the larger Zₘᵢₙ will be.

Thus, H₀ is rejected for large values of Zₘᵢₙ. Exact critical values of Zₘᵢₙ may be difficult to calculate. The critical values z_{α} of the standard normal distribution can be used, in which case the test may be conservative. Thus, the 97.5^{th} percentile of the standard normal distribution, Z_{0.025}=1.96, which may be used to test H₀ at the significance level α=0.025 as the critical value.

Above it is shown how the equivalence of three lots can be demonstrated in the case of a single strain, for example, in the case of a single outcome. However, current influenza vaccines, for example, contain HA of three strains (for example, an A-H₁N₁ strain, an A-H₃N₂ strain, and a B strain.) According, there may be three outcomes. The question then arises of whether and how to adjust for this type of multiplicity. The answer to this question is simplified if the point of view is taken that equivalence of the lots may be claimed if equivalence is demonstrated for all three strains. In this case, no adjustment of the test-wise significance levels may be needed. If H₀ is tested per strain at the significance level α and equivalence of the lots is concluded only if the null hypothesis is rejected for all three strains, then the probability of wrongly concluding that the three lots are equivalent may be α at most.

One difficult aspect of equivalence testing is the choice of the equivalence margin. If too small an equivalence margin is chosen, the sample size required to secure sufficient statistical power may be prohibitively large. If too large an equivalence margin is chosen, the results may be meaningless.

As stated above, for example, blood samples may be titrated twice. For example, the blood sample may be re-analyzed if two intra-individual HI titers differ by two or more dilution steps (e.g. 320 and 1280). However, if the two HI titers differ by only one step (e.g. 40 and 80), they may be considered to be identical. It is justifiable to allow at least the same difference between inter-individual HI titers and thus between lot means, in other words, to allow that 1<|Δᵢⱼ|<2. There are an infinite number of choices which satisfy this criterion, but given the discrete nature of the observations δ=1.5 may be an acceptable choice. This margin corresponds to the equivalence range of 2^{-1.5}=0.35 to 2^{+1.5}=2.83 for the GMR or the MFI ratio.

An embodiment consistent with the invention may comprise a system for providing lot consistency. The system may comprise a memory storage for maintaining a database and a processing unit coupled to the memory storage. The processing unit may be operative to receive level data elements, each one of the level data elements corresponding to one of the plurality of lots and one of the plurality of analytes. In addition, the processing unit may be operative to calculate, using a computer and the following equation, a plurality of test statistics, each one of the plurality of test statistics respectively corresponding to each one of the plurality of analytes,
Zmin=min{(δ−|Dᵢⱼ|)/seᵢⱼ},
where Dᵢⱼ comprises a difference between two of the level data elements for an i^{th} lot and a j^{th} lot for a given one of the plurality of analytes, seᵢⱼ comprises a standard error of the difference, and δ comprises an equivalence margin. Furthermore, the processing unit may be operative to determine that the plurality of lots are consistent when each of the plurality of test statistics exceed a predetermined value.

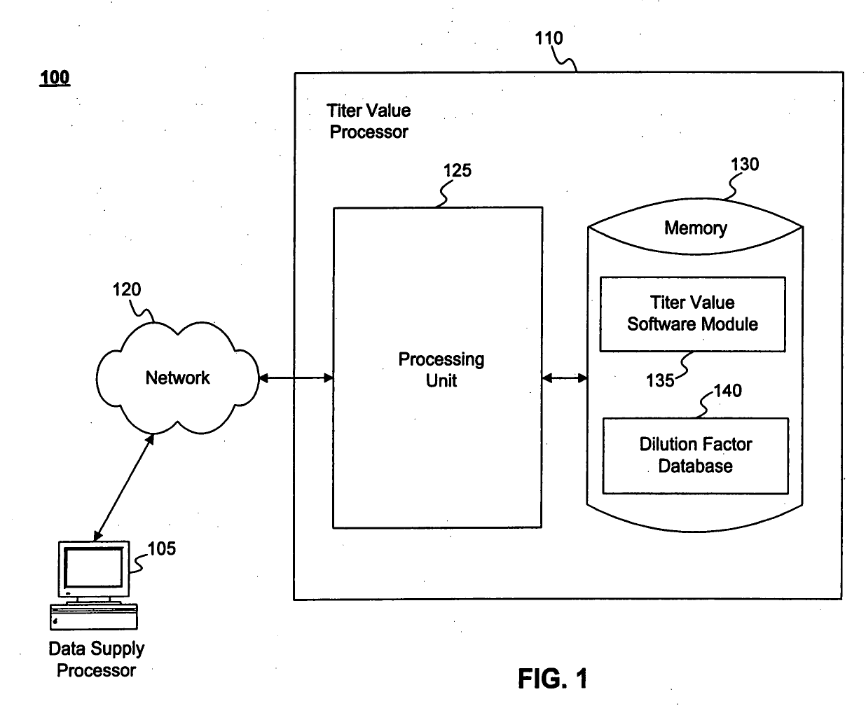

Consistent with an embodiment of the present invention, the aforementioned memory, processing unit, and other components may be implemented in a lot consistency system, such as an exemplary lot consistency system 100 of FIG. 1. Any suitable combination of hardware, software, and/or firmware may be used to implement the memory, processing unit, or other components. By way of example, the memory, processing unit, or other components may be implemented with any of a data supply processor 105 or a lot consistency processor 110, in combination with system 100. The aforementioned system and processors are exemplary and other systems and processors may comprise the aforementioned memory, processing unit, or other components, consistent with embodiments of the present invention.

Furthermore, the invention may be practiced in an electrical circuit comprising discrete electronic elements, packaged or integrated electronic chips containing logic gates, a circuit utilizing a microprocessor, or on a single chip containing electronic elements or microprocessors. The invention may also be practiced using other technologies capable of performing logical operations such as, for example, AND, OR, and NOT, including but not limited to mechanical, optical, fluidic, and quantum technologies. In addition, the invention may be practiced within a general purpose computer or in any other circuits or systems.

By way of a non-limiting example, FIG. 1 illustrates system 100 in which the features and principles of the present invention may be implemented. As illustrated in the block diagram of FIG. 1, system 100 may include data supply processor 105, lot consistency processor 110, a user 115, and a network 120. User 115 may be an individual, for example, desiring to determine lot consistency using consistency processor 110. User 115 may also be an organization, enterprise, or any other entity having such desires.

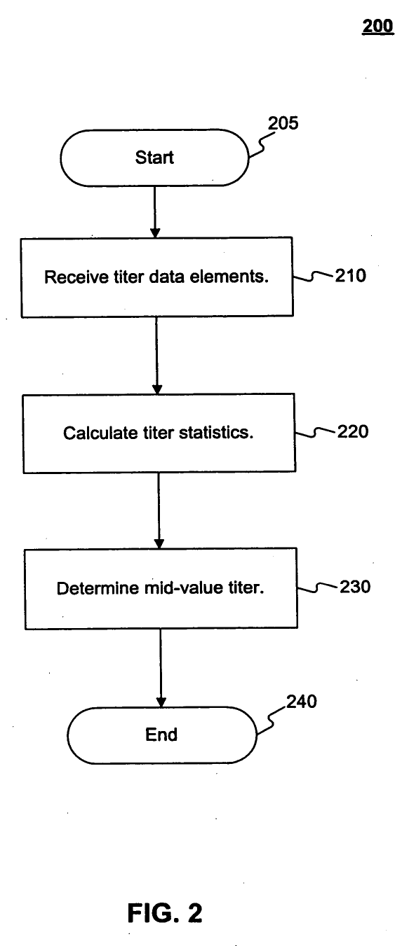

Lot consistency processor 110 may include a processing unit 125 and a memory 130. Memory 130 may include a lot consistency software module 135 and a lot consistency database 140. Software module 135 residing in memory 130 may be executed on processing unit 125, may access database 140, and may implement processes for determining lot consistency such as the method described below with respect to FIG. 2. Notwithstanding, processor 110 may execute other software modules and implement other processes.

Data supply processor 105 or lot consistency processor 110 (“the processors”) included in system 100 may be implemented using a personal computer, network computer, mainframe, or other similar microcomputer-based workstation. The processors may though comprise any type of computer operating environment, such as hand-held devices, multiprocessor systems, microprocessor-based or programmable sender electronic devices, minicomputers, mainframe computers, and the like. The processors may also be practiced in distributed computing environments where tasks are performed by remote processing devices. Furthermore, any of the processors may comprise a mobile terminal, such as a smart phone, a cellular telephone, a cellular telephone utilizing wireless application protocol (WAP), personal digital assistant (PDA), intelligent pager, portable computer, a hand held computer, a conventional telephone, or a facsimile machine. The aforementioned systems and devices are exemplary and the processor may comprise other systems or devices.

Network 120 may comprise, for example, a local area network (LAN) or a wide area network (WAN). Such networking environments are commonplace in offices, enterprise-wide computer networks, intranets, and the Internet, and are known by those skilled in the art. When a LAN is used as network 120, a network interface located at any of the processors may be used to interconnect any of the processors. When network 120 is implemented in a WAN networking environment, such as the Internet, the processors may typically include an internal or external modem (not shown) or other means for establishing communications over the WAN. Further, in utilizing network 120, data sent over network 120 may be encrypted to insure data security by using known encryption/decryption techniques.

In addition to utilizing a wire line communications system as network 120, a wireless communications system, or a combination of wire line and wireless may be utilized as network 120 in order to, for example, exchange web pages via the Internet, exchange e-mails via the Internet, or for utilizing other communications channels. Wireless can be defined as radio transmission via the airwaves. However, it may be appreciated that various other communication techniques can be used to provide wireless transmission, including infrared line of sight, cellular, microwave, satellite, packet radio, and spread spectrum radio. The processors in the wireless environment can be any mobile terminal, such as the mobile terminals described above. Wireless data may include, but is not limited to, paging, text messaging, e-mail, Internet access and other specialized data applications specifically excluding or including voice transmission.

System 100 may also transmit data by methods and processes other than, or in combination with, network 120. These methods and processes may include, but are not limited to, transferring data via, diskette, flash memory sticks, CD ROM, facsimile, conventional mail, an interactive voice response system (IVR), or via voice over a publicly switched telephone network.

FIG. 2 is a flow chart setting forth the general stages involved in an exemplary method 200 consistent with the invention for determining lot consistency between a plurality of lots using, for example, system 100 of FIG. 1. The plurality of lots may comprise, but are not limited to influenza vaccine lots. Furthermore, each lot may contain a plurality of analytes comprising, but not limited to, hemagglutinin (HA) corresponding to different viral strains. In other words, each analyte may correspond to HA for a different viral strain. Exemplary ways to implement the stages of exemplary method 200 will be described in greater detail below.

Exemplary method 200 may begin at starting block 205 and proceed to stage 210 where processor 110 may receive level data elements from, for example, from data supply processor 105. Data supply processor 105, for example, may be operated at a medical testing laboratory. The level data elements, for example, may comprise arithmetic means of log-transferred HI titers, as descried above, for different lots and analytes (e.g. strains.) For example, the arithmetic means of the log-transferred HI titers may be calculated using the GMTs of the post-vaccination HI titers. Table 1 shows exemplary GMTs of post-vaccination HI titers by lot (e.g. Lot 1, Lot 2, and Lot 3) and per strain (e.g. A-H₁N₁, A-H₃N₂, and B.) As shown in Table 1, GMTs were highest for the B strain and, with one exception, lowest for the A-H₁N₁ strain. The data shown in Table 1 may be obtained from blood samples taken from subjects previously injected with vaccine from the given lots tested by anti-HA antibody titration. Furthermore Table 1 shows the sample size “n” for each lot.

TABLE 1

| Viral strain | Lot 1 | Lot 2 | Lot 3 |
|---|---|---|---|
| type | (n = 123) | (n = 123) | (n = 117) |
| A-H₁N₁ | 151.4 | 163.4 | 150.3 |
| A-H₃N₂ | 192.9 | 162.2 | 202.5 |
| B | 352.6 | 365.0 | 372.7 |

The GMTs of the post-vaccination HI titers shown in Table 1 may be used to calculate the arithmetic means of the log-transferred HI titers shown in Table 2 below. This calculation is described above. Table 2, shows exemplary arithmetic means and standard deviations (in brackets) of the log-transformed HI titers by lot (e.g. Lot 1, Lot 2, and Lot 3) and per strain (e.g. A-H₁N₁, A-H₃N₂, and B.) Consistent with an embodiment of the invention, GMTs of the post-vaccination HI titers and/or the arithmetic means of the log-transferred HI titers may be calculation on either of data supply processor 105 and lot consistency processor 110.

TABLE 2

| Viral strain | Lot 1 | Lot 2 | Lot 3 |
|---|---|---|---|
| type | (n = 123) | (n = 123) | (n = 117) |
| A-H₁N₁ | 4.92 | 5.03 | 4.91 |
| | (1.69) | (1.65) | (1.65) |
| A-H₃N₂ | 5.27 | 5.02 | 5.34 |
| | (1.57) | (1.60) | (1.57) |
| B | 6.14 | 6.19 | 6.22 |
| | (1.20) | (1.21) | (1.28) |

From stage 210, where processor 110 receives the level data elements, exemplary method 200 may advance to stage 220 where processor 110 may calculate a plurality of test statistics. Each one of plurality of test statistics may respectively correspond to each of the plurality of analytes. Furthermore, each one of plurality of test statistics may comprise, but is not limited to, Zₘᵢₙ calculated as described above for each analyte (strain.) For example,
Zmin=min{(δ−|Dᵢⱼ|)/seᵢⱼ},
where Dᵢⱼ may comprise an difference between the arithmetic means of the log-transformed HI titers for an i^{th} and a j^{th} lot, seᵢⱼ may comprise a standard error of that difference, and δ may comprise an equivalence margin described above.

For the A-H₁N₁ strain data shown in Table 2, the observed differences are: D₁₂=+0.11, D₁₃=−0.01 and D₂₃=−0.12. The standard deviations of the lot means are: sd₁=1.69 and sd₂=sd₃=1.65. Hence, the standard errors of the differences (the calculation of which is described in detain above) are:
s₁₂=√[1.69²/123+1.65²/123]=0.21
s₁₃=√[1.69²/123+1.65²/117]=0.22
s₂₃=√[1.65²/123+1.65²/117]=0.21.

This gives, for the A-H₁N₁ strain data shown in Table 2, (where δ=1.5)
Zmin=min{(1.5−0.11)/0.21, (1.5−0.01)/0.22, (1.5−0.12)/0.21}=6.57
Accordingly, the value of the test statistic for the A-H₁N₁ strain data shown in Table 2 is 6.57. Also, from the data shown in Table 2, Zₘᵢₙ may be calculated as 5.90 and 8.88 for the A-H₃N₂ and the B strains respectively. Consequently, the value of the test statistic (e.g. Zₘᵢₙ) for the A-H₁N₁, A-H₃N₂, and the B strains may be 6.57, 5.90, and 8.88 respectively.

Once processor 110 calculates the plurality of test statistics in stage 220, exemplary method 200 may continue to stage 230 where processor 110 may determine that the plurality of lots are consistent when each of the plurality of test statistics exceed a predetermined value. For example, as described above, even if the conservative critical value based on normal distribution is used for the predetermined value (i.e. z_{0.025}=1.96), the null hypothesis that the three lots (as descried above with respect to Table 2, for example) are not equivalent can be rejected for the A-H₁N₁ strain, the A-H₃N₂ strain, and the B strain respectively. In other words the value of each of the plurality of test statistics exceed 1.96. Thus, the null hypothesis that the three lots are not equivalent can also be rejected for all three strains. Because the null hypotheses were rejected for all three strains, equivalence of the three lots (Lot 1, Lot 2, and Lot 3) as described above with respect to Table 2 is shown. After processor 110 determines that the plurality of lots are consistent when each of the plurality of test statistics exceed the predetermined value in stage 230, exemplary method 200 may then end at stage 240.

A critical value based on normal distribution was used in the above calculation with respect to stage 230 in exemplary method 200. As outlined, however, less conservative critical values c_{α} may be used. For example, the c_{α} may depend on two parameters, δ/se and p. The first parameter may be defined as:
δ/se=δ/√[2 min sd₁2/nᵢ],
and the second parameter may be defined as:
p=Δ₁₂/Δ₁₃.
Because this ratio (p) is unknown, p may be set to ½. For the A-H₁N₁ strain described above with respect to Table 2, δ/se=7.13. For δ/se>5, c_{0.025}≈1.96, so there may be no advantage. However, if δ/se had been equal to 2.75, then c_{0.025}=1.71, which may have meant a considerable gain in statistical power.

As a comparison, the arithmetic means and standard deviations of the log-transformed fold increases for the data shown in Table 1 are shown in Table 3.

TABLE 3

| Viral strain | Lot 1 | Lot 2 | Lot 3 |
|---|---|---|---|
| type | (n = 123) | (n = 123) | (n = 117) |
| A-H₁N₁ | 4.51 | 4.39 | 4.48 |
| | (1.82) | (1.69) | (1.89) |
| A-H₃N₂ | 3.73 | 3.64 | 3.65 |
| | (2.04) | (1.98) | (2.21) |
| B | 3.78 | 3.46 | 3.59 |
| | (2.27) | (2.38) | (2.38) |

For the A-H₁N₁ strain, the observed differences are: D₁₂=−0.12, D₁₃=−0.03, and D₂₃=+0.09. The standard deviations of the lot means are: sd₁=1.82 and sd₂=1.69 and sd₃=1.89. Accordingly, the observed differences are of the same general magnitude as those found for the log-transformed HI titers shown in Table 2, the standard deviations, however, are larger. This may confirm, for the A-H₁N₁ strain, that an analysis based on fold increases may have been less powerful (i.e. smaller, less significant value for Zₘᵢₙ) than that based on HI titers. The same applies to the two other strains shown in Tables 1, 2, and 3.

Consistent with an embodiment of the invention, exemplary method 200, for example, may show how two types of multiplicity can be dealt with. A first type—multiple comparisons between lots—can be handled by applying a statistical method to test the equivalence of three analytes, for example. Moreover, consistent with an embodiment of the invention, exemplary method 200, for example, may show a second type—multiple comparisons because of more than one strain may be ignored (i.e. that no adjustment is needed.)

In an embodiment, the invention provides a method for determining lot consistency between a plurality of lots, each of the plurality of lots being associated with each of a plurality of analytes. The method may comprise, for example, manufacturing the lots and taking samples from them, analyzing the analytes in the samples, and generating level data elements from the analyses, wherein each one of the level data elements corresponds to one of the plurality of lots and one of the plurality of analytes. The method may further comprise, for example, calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},

where Dᵢⱼ comprises a difference between two of the level data elements for an i^{th} lot and a j^{th} lot for a given one of the plurality of analytes, seᵢⱼ comprises a standard error of the difference, and δ comprises an equivalence margin. The method may further comprise, for example, determining whether each of the plurality of test statistics exceeds a predetermined value and thus the plurality of lots are consistent. The consistency determination may be used, for example, to take a decision to use the lots, and/or to discard them, and/or to adjust the manufacturing process.

This aspect of the invention may be used as the basis for an assay to determine the quality of a manufactured vaccine lot. In the case of influenza vaccines, the vaccine manufacturing process may comprise growing virus, for instance on egg or in cell culture, and harvesting the antigen (which may comprise one or more of inactivation, solubilisation and purification). In this context, the analyte may be, for example, an immunogenic component of the vaccine. If the vaccine is an influenza vaccine the analyte may be a component of an influenza virus, such as hemagglutinin (HA) or neuraminidase (NA). Subsequently, subjects may be immunized with the vaccine, blood samples may taken from said subjects, and the antibody response determined. The method may be practiced with vaccine compositions that contain one or more than one analytes.

While certain features and embodiments of the invention have been described, other embodiments of the invention will be apparent to those skilled in the art from consideration of the specification and practice of the embodiments of the invention disclosed herein. Furthermore, although embodiments of the present invention have been described as being associated with data stored in memory and other storage mediums, one skilled in the art will appreciate that these aspects can also be stored on or read from other types of computer-readable media, such as secondary storage devices, like hard disks, floppy disks, or a CD-ROM, a carrier wave from the Internet, or other forms of RAM or ROM. Further, the steps of the disclosed methods may be modified in any manner, including by reordering steps and/or inserting or deleting steps, without departing from the principles of the invention.

It is intended, therefore, that the specification and examples be considered as exemplary only, with a true scope and spirit of the invention being indicated by the following claims and their full scope of equivalents.

What is claimed is:

1. A method for determining lot consistency between a plurality of lots, each of the plurality of lots being associated with each of a plurality of analytes, the method comprising:
receiving level data elements, each one of the level data elements corresponding to one of the plurality of lots and one of the plurality of analytes;
calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},
where Dᵢⱼ comprises a difference between two of the level data elements for an i^{th} lot and a j^{th} lot for a given one of the plurality of analytes, seᵢⱼ comprises a standard error of the difference, and δ comprises an equivalence margin; and
determining that the plurality of lots are consistent when each of the plurality of test statistics exceeds a predetermined value.

2. The method of claim 1, wherein the lots are vaccine lots.

3. The method of claim 2, wherein the level data elements are a measure of the immunogenicity of the vaccine lots.

4. The method of claim 2, wherein the vaccine is influenza vaccine and the level data elements correspond to the immunogenicity of the influenza vaccine.

5. The method of claim 4, wherein the immunogenicity of the influenza vaccine is determined by the hemagglutination inhibition test for anti-HA antibody titration.

6. The method of claim 1, further comprising transforming non-normally distributed level data elements to obtain normally distributed level data elements.

7. The method of claim 1, wherein δ is from 1.3 to 1.7.

8. The method of claim 1, wherein δ is from 1.4 to 1.6.

9. The method of claim 1, wherein δ/seᵢⱼ is 5.0 or less.

10. The method of claim 1, wherein each one of the plurality of lots is associated with more than one analyte, and wherein a level data element corresponding to each of the more than one analytes associated with each of the plurality of lots is determined.

11. A method for determining lot consistency between a plurality of lots, each of the plurality of lots being associated with each of a plurality of analytes, the method comprising:
receiving level data elements, each one of the level data elements corresponding to one of the plurality of lots and one of the plurality of analytes;
calculating, using the following equation, a plurality of test statistics, each one of the plurality of test statistics respectively corresponding to each one of the plurality of analytes,
Zmin=min{(δ−|Dᵢⱼ|)/seᵢⱼ},
where Dᵢⱼ comprises a difference between two of the level data elements for an i^{th} lot and a j^{th} lot for a given one of the plurality of analytes, seᵢⱼ comprises a standard error of the difference, and δ comprises an equivalence margin; and
determining that the plurality of lots are consistent when each of the plurality of test statistics exceeds a predetermined value.

12. A system for determining lot consistency between a plurality of lots, each of the plurality of lots being associated with each of a plurality of analytes, the system comprising
a memory storage for maintaining a database and a processing unit coupled to the memory storage, wherein the processing unit is operative to:
receive level data elements, each one of the level data elements corresponding to one of the plurality of lots and one of the plurality of analytes; and
calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},
where Dᵢⱼ comprises a difference between two of the level data elements for an i^{th} lot and a j^{th} lot for a given one of the plurality of analytes, seᵢⱼ comprises a standard error of the difference, and δ comprises an equivalence margin, and determining that the plurality of lots are consistent when each of the plurality of test statistics exceeds a predetermined value.

13. The system of claim 12, wherein the lots are vaccine lots.

14. The system of claim 13, wherein the level data elements are a measure of the immunogenicity of the vaccine lots.

15. The system of claim 13, wherein the vaccine is influenza vaccine and the level data elements correspond to the immunogenicity of the influenza vaccine.

16. The system of claim 15, wherein the immunogenicity of the influenza vaccine is determined by the hemagglutination inhibition (HI) test for anti-HA antibody titration.

17. The system of claim 12, wherein the processing unit is operative to transform non-normally distributed level data elements to obtain normally distributed level data elements.

18. The system of claim 12, wherein δ is from 1.3 to 1.7.

19. The system of claim 12, wherein δ is from 1.4 to 1.6.

20. The system of claim 12, wherein δ/seᵢⱼ is 5.0 or less.

21. The system of claim 12, wherein each one of the plurality of lots is associated with more than one analyte, and wherein a level data element corresponding to each of the more than one analytes associated with each of the plurality of lots is determined.

22. A computer-readable medium which stores a set of instructions which when executed performs a method for determining lot consistency between a plurality of lots, each of the plurality of lots being associated with each of a plurality of analytes, the method executed by the set of instructions comprising:
receiving level data elements, each one of the level data elements corresponding to one of the plurality of lots and one of the plurality of analytes; and
calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},
where Dᵢⱼ comprises a difference between two of the level data elements for an i^{th} lot and a j^{th} lot for a given one of the plurality of analytes, seᵢⱼ comprises a standard error of the difference, and δ comprises an equivalence margin, and determining that the plurality of lots are consistent when each of the plurality of test statistics exceeds a predetermined value.

23. The computer-readable medium of claim 22, wherein the lots are vaccine lots.

24. The computer-readable medium of claim 23, wherein the level data elements are a measure of the immunogenicity of the vaccine lots.

25. The computer-readable medium of claim 23, wherein the vaccine is influenza vaccine and the level data elements correspond to the immunogenicity of the influenza vaccine.

26. The computer-readable medium of claim 25, wherein the immunogenicity of the influenza vaccine is determined by the hemagglutination inhibition (HI) test for anti-HA antibody titration.

27. The computer-readable medium of claim 22, wherein the instructions further comprise transforming non-normally distributed level data elements to obtain normally distributed level data elements.

28. The computer-readable medium of claim 22, wherein δ is from 1.3 to 1.7.

29. The computer-readable medium of claim 22, wherein δ is from 1.4 to 1.6.

30. The computer-readable medium of claim 22, wherein δ/seᵢⱼ is 5.0 or less.

31. The computer-readable medium of claim 22, wherein each one of the plurality of lots is associated with more than one analyte, and wherein a level data element corresponding to each of the more than one analytes associated with each of the plurality of lots is determined.

32. A method for determining lot consistency between a plurality of lots, each of the plurality of lots being associated with each of a plurality of analytes, the method comprising:
manufacturing the lots and taking samples from the lots, analyzing the analytes in the samples, and generating level data elements from the analyses, wherein each one of the level data elements corresponds to one of the plurality of lots and one of the plurality of analytes;
calculating, using a computer and the following equation, a plurality of test statistics, each one of the plurality of test statistics respectively corresponding to each one of the plurality of analytes,
Zmin=min{(δ−|Dᵢⱼ|)/seᵢⱼ},
where Dᵢⱼ comprises a difference between two of the level data elements for an i^{th} lot and a j^{th} lot for a given one of the plurality of analytes, seᵢⱼ comprises a standard error of the difference, and δ comprises an equivalence margin; and
determining whether each of the plurality of test statistics exceeds a predetermined value and thus the plurality of lots are consistent;
and, based on said consistency determination, determining whether to use and/or to discard each of the lots, and/or to adjust the manufacturing process.
